(19) United States
(12) Patent Application Publication
(10) Pub. No.: US 2017/0041848 A1
(43) Pub. Date: Feb. 9, 2017

(54) METHOD AND DEVICE FOR DATA PROCESSING IN A MOBILE COMMUNICATION NETWORK

(71) Applicant: Nokia Solutions and Networks Oy, Espoo (FI)

(72) Inventors: Ingo Viering, Munich (DE); Martin Doettling, Neubiberg (DE); Richard Waldhauser, Munchen (DE)

(73) Assignee: Nokia Solutions and Networks Oy

(21) Appl. No.: 15/283,792

(22) Filed: Oct. 3, 2016

Related U.S. Application Data
(63) Continuation of application No. 13/257,135, filed on Sep. 16, 2011, now abandoned.

(51) Int. Cl. H04W 36/22; H04W 36/00; H04W 36/38

(52) U.S. Cl. CPC H04W 36/22; H04W 36/38; H04W 36/0083

(57) ABSTRACT

A method and a device for data processing in a mobile are provided, wherein a handover parameter of at least one cell is negotiated between a first cell and a second cell based on a load situation at the first cell and/or at the second cell.

The invention relates to a method and to a device for data processing in a mobile communication network.

The approach in particular relates to mobile wireless communications, e.g., to 3GPP Long-Term Evolution (LTE as well as LTE-Advanced), in particular to managing load-related aspects of a self-organizing network (SON).

In a handover situation, a mobile terminal (also referred to as user equipment (UE)) is connected from one base station to another (target) base station. The base station may also be referred to as cell, which basically is an area served by the base station. It is noted that a base station, e.g., an eNB, may serve several cells.

When a source cell requests a handover to a target cell, the source cell can indicate a cause for such handover, e.g., “load balancing”.

Negotiating cell-pair specific handover offsets has been discussed in 3GPP. Such handover offsets can be used to obtain stability of load balancing handover (LB-HO) decisions made by a load balancing algorithm, i.e. to prevent handovers back to the overloaded cell. Such a handover back to the overloaded cell is likely to occur, as the mobile terminal (e.g., in active or in idle mode) may not intend to change the cell to which it is currently connected, because from a radio transmission perspective the mobile terminal is served best by this cell. Hence, the mobile terminal will be recognized as a promising HO candidate for radio reasons after having performed a LB-HO to a neighbor cell. This, however, does not lead to an efficient distribution of the overall load among several cells, instead it results in additional traffic based on repeated and futile handovers.

The problem to be solved is to overcome the disadvantages stated above and in particular to define an efficient trigger criterion for modifying a cell-specific handover offset of a base station, in particular of an eNB.

This problem is solved according to the features of the independent claims. Further embodiments result from the depending claims.

In order to overcome this problem, a method is suggested for data processing in a mobile communication network, wherein a handover parameter of at least one cell is negotiated between a first cell and a second cell based on a load situation at the first cell and/or at the second cell.

It is noted that cell in particular refers to an area that is served by a base station. The first cell and the second cell may be served by different base stations, e.g., by different eNBs. A cell performing an action is defined as the base station serving this cell performing said action. However, the base station may provide several (different) actions for different cells associated with this base station.

The handover parameter of each cell may comprise a field of values. In addition, also several handover parameters may be negotiated (and set) between the first cell and the second cell.

It is further noted that the handover parameter of at least one cell being negotiated between said first cell and said second cell can be set for either the first cell or the second cell or both.

Hence, the approach suggested allows for a trigger initiating a negotiation of the parameters to be modified. Such trigger may be defined in an efficient manner to ensure the stability of the load balancing.

Advantageously, the load balancing suggested allows for a joint adjustment of handover parameters, (e.g., handover-offset parameters), which can be defined per cell, in particular per cell pair. Thus, one or two network elements, in particular base stations (Nodes, eNBs) may adapt according to such parameters.

A part of the load balancing functionality may be located and/or associated decentralized in the base stations (e.g., eNBs), wherein a basic configuration and management functionality can be performed by or associated with a central SON entity, which may be deployed with a management plane.

The approach suggested may be applicable in a decentralized manner, i.e. the involved base stations may directly negotiate offset value(s). This bears the advantage that the decentralized negotiation requires less signaling and coordination effort than a centralized negotiation, because in case of the cell-pair specific offset parameters just two base stations get involved. Another advantage is based on the fact that time constraints can be more easily met by the decentralized approach. However, the centralized approach is also applicable and can be used to apply the concepts suggested herein. Also, a mixture of centralized and decentralized approach can be provided (referred to also as hybrid approach).

The base stations (e.g., eNBs) have a more detailed and a more up-to-date knowledge concerning, e.g., the load status of the own cells as well as the load status of cells associated with neighboring base stations due to a X2 resource status reporting.

This approach is applicable for FDD and/or TDD technologies and can be applied to all kind of mobile networks, e.g., GSM, 3G, LTE.

In an embodiment, the handover parameter comprises at least one handover offset, in particular a handover offset value for each of the first cell and the second cell, wherein the handover offset values correspond to one another.

The corresponding handover offset values for paired cells (here: the first cell and the second cell) ensure that the area between the cells is being served without any significant supply gap. Hence, if the first cell reduces its size, the second cell increases its size accordingly by corresponding handover offset values. The same applies vice versa.

In another embodiment, based on the handover parameter negotiation, handover for at least one mobile terminal from the first cell to the second cell is initiated.

Hence, the first cell may efficiently utilize the load situation at the second cell to proceed with or initiate handover of at least one mobile terminal. Advantageously, such handover may relate to several mobile terminals.

In a further embodiment, the load situation of the second cell is conveyed to the first cell and/or the load situation of the first cell is conveyed to the second cell.

The load situation may be conveyed directly from one cell to another or via a central entity.

In a next embodiment, the load situation is conveyed via a status report comprising in particular at least one of the following:
A quality-of-service information;
at least one limitation relating to the potential target cell;
an effective load of the potential target cell;
a hardware load;
a transport network layer load;
a radio network layer load;
a backhaul limitation.

Said status report is also referred to as load report conveying the load situation of, e.g., the potential target cell. The status report may be compressed to at least one field or number indicating the actual effective load that can efficiently be utilized by the source cell.

The status report can be conveyed in a periodic manner and/or it may be event-triggered, e.g., on request or in case a predetermined condition is met.

It is also an embodiment that the handover parameter of the at least one cell is negotiated after at least one load balancing handover has been conducted.

This is also referred to as “trailing” negotiation. The reason for the handover can be indicated by a cause value. The cause value can be conveyed from the source cell to the target cell. The target cell may reject a handover for LB reasons, but still allow handover due to radio reasons.

In particular, a timer can be utilized starting with the first handover of a mobile terminal and considering further handovers that have been conducted within the interval of this timer. These handovers are utilized to negotiate or determine the handover parameter by the first cell (source cell, in particular the base station operating the first cell). This bears the advantage that the negotiation can rely on LB-HOs that have already been performed and is thus rather accurate.

Pursuant to another embodiment, the handover parameter of the at least one cell is negotiated before at least one load balancing handover is conducted.

This approach has the advantage that a LB-HO is only conducted if the cells agree on the changed handover parameter, in particular handover offset.

According to an embodiment, the handover parameter of the at least one cell is negotiated before at least one load balancing handover is conducted; and the handover parameter of the at least one cell is conducted for several mobile terminals.

This approach bears the advantage that in case of a load change, the load balancing function may shift several mobile terminals to a target cell thereby significantly reducing the signaling load required for negotiating the handover parameter.

According to another embodiment, the handover parameter of the at least one cell is negotiated for mobile terminals being in active and/or being in idle mode.

It may be advantageous to be able to select whether the negotiation shall affect mobile terminals in active mode or in idle mode only.

In yet another embodiment, the handover parameter of the at least one cell is negotiated comprising the steps:
The first cell informs the second cell about a handover parameter setting;
the second cell confirms this handover parameter setting or it suggests a different handover parameter setting or it rejects the handover parameter setting.

It is noted that the different handover parameter suggested may be smaller than the handover parameter provided by the first cell. This allows that the handover parameter negotiated between the first cell and the second cell converges. This scenario in particular applies in case the handover parameter is or comprises a handover offset. Basically, the different handover parameter setting may comprise a parameter that is subject to particular rules or conditions that allow for a converging negotiation.

The first cell may suggest a different handover parameter setting upon receiving either the different handover parameter setting or a rejection of the handover parameter setting suggested. Both, the first cell and the second cell may confirm a handover parameter setting, which may indicate a successful negotiation. The handover parameter agreed on may be utilized for configuration purposes in the first cell as well as in the second cell.

According to a next embodiment, the handover parameter of the at least one cell is negotiated between the first cell and the second cell via a central entity.

Hence, a direct message exchange for negotiation purposes between adjacent cells is not required. Instead, a centralized load balancing function may retrieve information from both cells and provide for the negotiation regarding the handover parameter. The centralized function could be located in or be associated with any Element Manager, OAM node or an independent network element dedicated to provide SON functionality.

Pursuant to yet an embodiment, at least one centralized service is provided by an OAM function.

According to a further embodiment, load balancing is switched off for at least one cell via said OAM function.

Hence, the cell excluded from load balancing is not able to request LB or to initiate LB-HOs. It may also be excluded from suggesting handover parameters to other cells.

According to yet an embodiment, the OAM function provides an upper threshold for load balancing for at least one cell and/or a lower threshold for load balancing for at least one cell.

When the lower threshold is reached, the cell may be switched off for energy saving reasons. The upper threshold can be used to initiate load balancing. Different—in particular separate—thresholds can be utilized for different resource types, e.g., transport network load, hardware load, radio load, and/or for different bearer types, e.g., signaling radio bearers, GBR bearers, non-GBR bearers.

The problem stated above is also solved by a device comprising a and/or being associated with a processor unit and/or a hard-wired circuit and/or a logic device that is arranged such that the method as described herein is executable thereon.

Said device may be a or may be associated with a network component, in particular a base station or a central network element, e.g., a OAM system.

The problem stated supra is further solved by a communication system comprising the device as described herein.

Embodiments of the invention are shown and illustrated in the following figures:

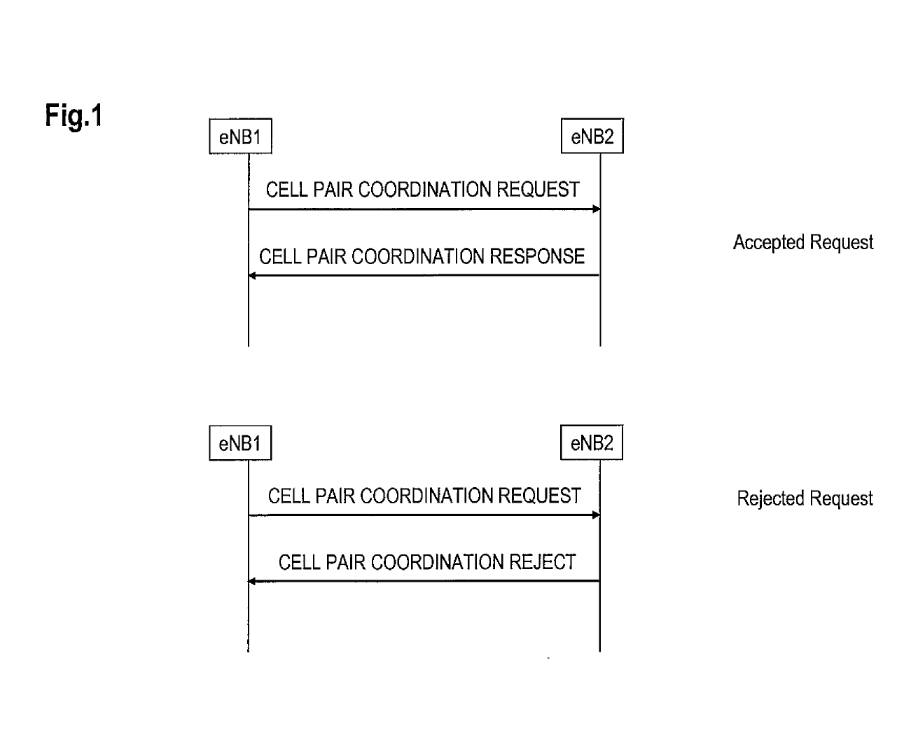

FIG. 1 shows a message sequence diagram comprising a handover parameter coordination procedure in a distributed approach comprising the case of an accepted request and the case of a rejected request between two eNBs;

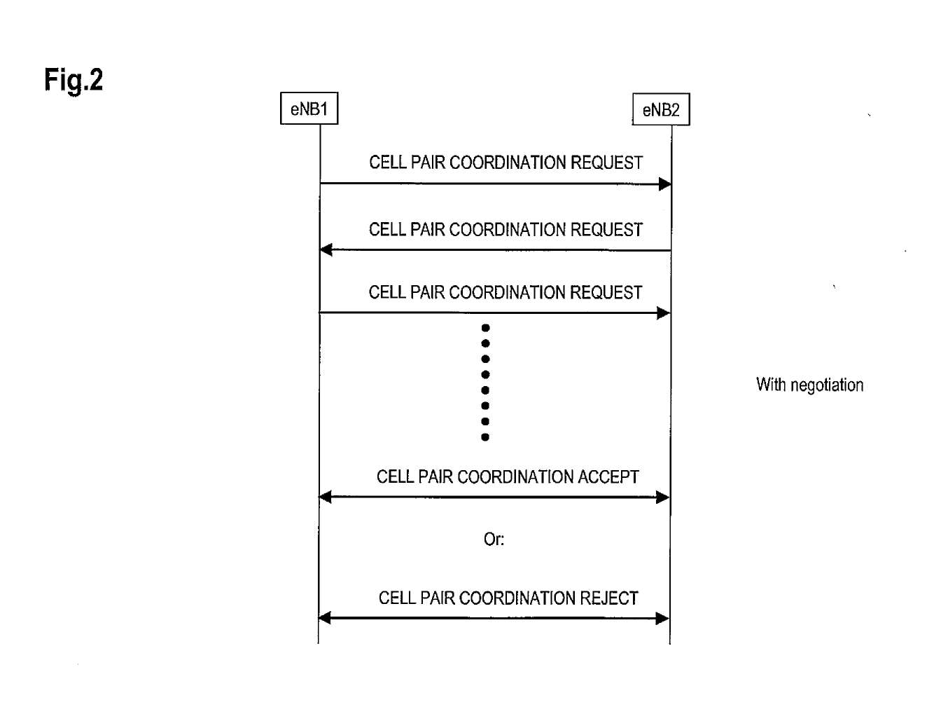

FIG. 2 shows a message diagram depicting an alternative handover parameter coordination procedure in a distributed approach comprising the case of an accepted request and the case of a rejected request between two eNBs;

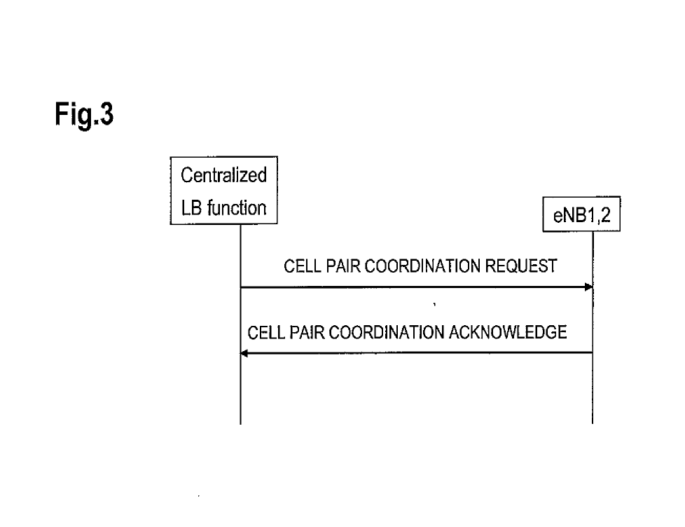

FIG. 3 shows a message diagram visualizing a centralized approach for a handover coordination procedure between a centralized function and a eNB allowing for cell-pair specific offset modifications for a system that is controlled by a centralized load balancing function;

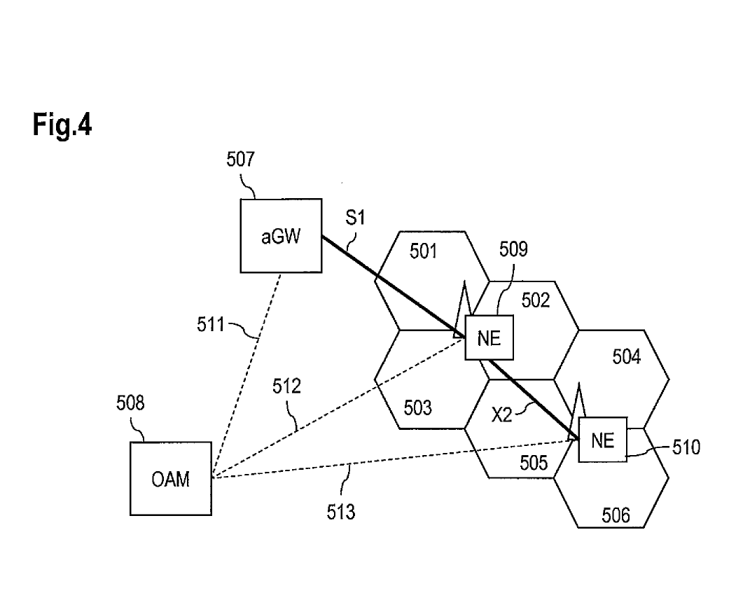

FIG. 4 shows the overall LB architecture and the function split between centralized and decentralized load balancing approach;

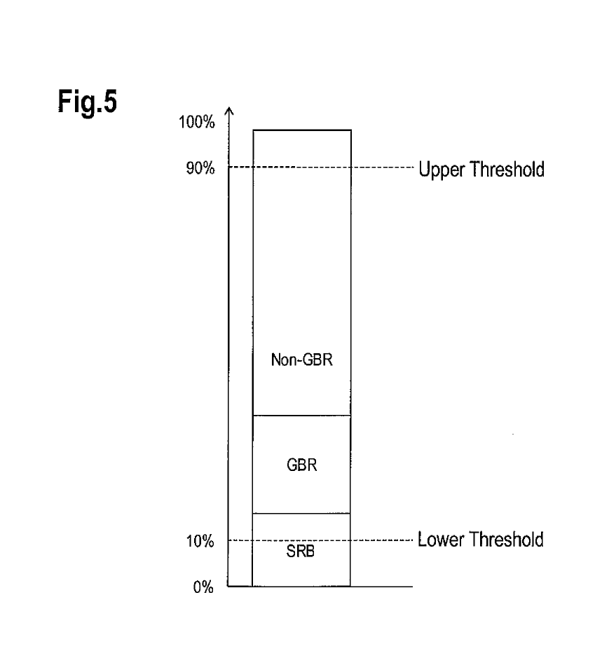

FIG. 5 shows an example of load balancing thresholds with an upper threshold for the load set by OAM to 90% PRB usage and a lower threshold set to 10%;

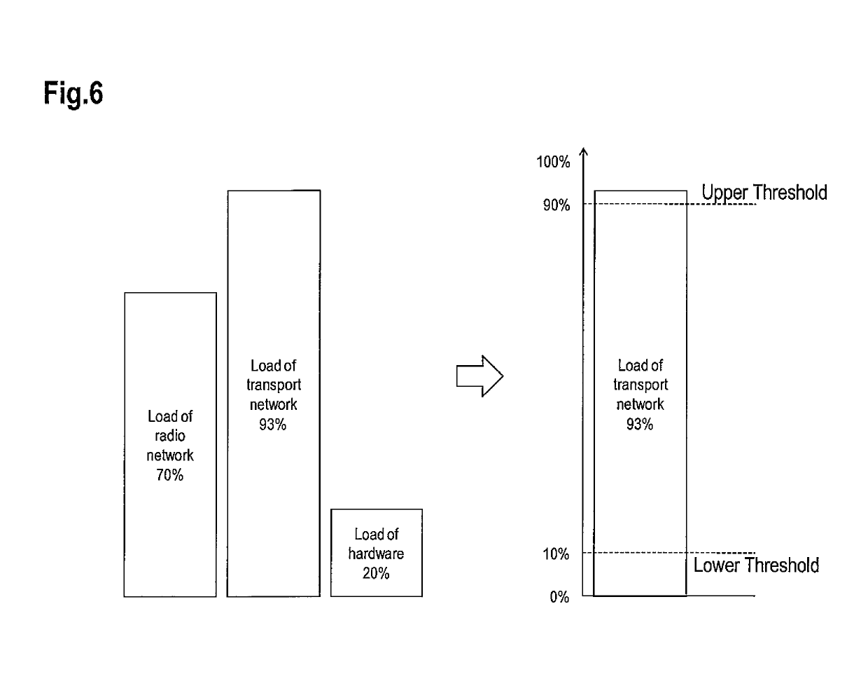

FIG. 6 shows the use of a compound load balancing threshold, wherein the maximum load is determined via the resources radio network, transport network and hardware.

The approach provided herein in particular determines an efficient or advantageous trigger criterion for initiating a negotiation for new cell-pair specific handover offset(s).

This can be used for load balancing purposes, in particular as a functionality of a self-organizing network (SON).

The trigger may be also referred to as any kind of activation and may be timely coupled with a handover, said handover being in particular causal to an action of load balancing (LB), e.g., an action initiated by a load balancing algorithm. For example, said negotiation can be triggered when a LB timer expires.

The LB timer may have to be set to a duration being smaller than a duration of a hysteresis timer that is used for load balancing handover (LB-HO) purposes. Such hysteresis timer may ensure that a mobile terminal just handed over to a target cell stays at least for a particular duration set by the hysteresis timer with the target cell. The LB timer may be started when the first LB-HO is processed.

It is noted that the target cell may refer in particular to a cell associated with a target eNB, whereas a source cell is associated with a source eNB. Hence, although each eNB may comprise several cells, the source cell and the target cell are served by different eNBs.

The mobile terminal mentioned herein refers to any device capable of data communication over a radio interface, in particular a mobile phone, a user equipment (UE), a laptop, a personal digital assistant or any other machine.

The trigger can be used in centralized, in decentralized or in hybrid applications of the load balancing function. In the hybrid scenario, the LB function can be deployed partly in a centralized and partly in a decentralized manner.

The approach described herein utilizes a cell-pair specific offset for active mode UEs according to existing cell-pair specific handover offsets that are used for
(a) active mode UEs to trigger measurement reports (Ocn, cellIndividualOffset respectively as set forth in 3GPP TS 36.331),
(b) idle mode UEs to have an impact on a cell for the UEs to camp on (Qoffsets, n defined in 3GPP TS 36.304).

### Trigger of Negotiation

Here, the trigger criteria associated with the offset negotiation are described in further detail. The following options relating to the time when a new handover offset is negotiated may be applicable:
(1) Offset negotiation after a LB-HO has been performed (in the following also referred to as a “trailing negotiation”):
   The negotiation is triggered after the LB-HO has been performed. The negotiation should not fail, because the LB-HO has already been accepted by the target eNB and has already been executed.
   A trailing negotiation may modify a HO parameter “cell-pair specific offset” corresponding to the amended, already realized condition.
   In case of an abrupt load change, e.g., moving many UEs to a rather unloaded cell of a neighbor eNB, a ping-pong timer (e.g., a timer TreselectionRAT (according to 3GPP TS 36.304) for idle mode UEs or a timer TimeToTrigger (according to 3GPP TS 36.331) for active mode UEs) can be utilized. This enables the source eNB (which may experience a rather overload situation and wants to initiate LB in order to efficiently distribute the overall load situation among several cells) to initiate several LB-HOs until the timer of the first HO has expired, or until such timer is close to expiration. This can be done in case the value of the ping-pong timer, which is used in the target eNB, is known to the source eNB.
   Then, the source eNB starts a single offset negotiation that considers all the LB-HOs that were successfully executed during this period of time of the ping-pong timer. The minimum value for the ping-pong timer is defined to amount to 1 sec according to 3GPP specification. Hence, if the duration of the ping-pong timer used by the target eNB is not known to the source eNB, the source eNB may assume and utilize the minimum value of 1 sec.
   This scenario may require a timer which is to be maintained by the source eNB itself, or it may be centrally provided by OAM. According to this scenario, LB-HOs may be efficiently conducted. Advantageously, several LB-HOs can be handled by a single offset negotiation. This negotiation is rather accurate, because it relies on already performed LB-HOs.
   It is another advantage that the LB-HOs can be identified by a cause value. Such cause value can indicate to the target eNB the reason for the handover of a particular UE to be “LB”. Hence, the target eNB may reject such a handover request based on “LB” (indicated by said cause value “LB”) and it may still allow “normal” HOs to be performed for radio reasons.
   Such scenario could be applicable in case a neighbor eNB of the target eNB gets overloaded, e.g., when another neighbor eNB is simultaneously performing LB-HOs to the same target eNB.
(2) Offset negotiation before each individual LB-HO is initiated:
   This scenario bears the advantage that no LB-HO will be initiated if the cells cannot agree on a new offset. Without such agreement, initiating the LB-HO does not make sense, because the UE will very likely return to the source cell, where it experiences better radio transmission conditions.
   If the negotiation is agreed on, the LB-HO can be triggered. Hence, the handover may not be recognized by the target eNB as a LB-HO, it appears like a “Handover Desirable for Radio Reasons” according to the already modified HO offset.
   The target cell may not be able to distinguish between LB-HOs that are initiated by the LB function and HOs that are initiated for radio reasons.
   In case of an abrupt load increase, a new offset may have to be negotiated for every UE that shall perform a handover for load balancing reasons.
(3) Offset negotiation as a “proactive negotiation”:
   In this scenario, the trigger for the negotiation is provided prior to the actual LB-HOs being initiated.
   The difference to the previous alternative (2) is that the negotiation is not done per UE. Instead the negotiation of the cell-pair specific handover offset value considers several UEs, in particular a larger number of UEs, that need to be moved to the target eNB.
   With respect to previous alternative (2) this bears the advantage that in case of abrupt load change, which would require the load balancing function to shift a large number of users to an empty or low loaded cell of the neighbor eNB, this scenario (3) reduces the signaling load caused by the offset negotiation. The offset negotiation may consider a number of UEs that the neighbor eNB is assumed to accept for the intended target cell, e.g., based on the load status reporting provided by the target eNB.
   Such “proactive HO offset” is thus adjusted to the load status of the target cell of the adjacent eNB and could with high likelihood be accepted by the target cell thereby resulting in the HOs as desired by the source eNB.

### New Cell-Pair Specific Offset Value for Active Mode UEs:

According to idle mode and active mode measurement trigger, it may be advantageous to adjust cell-pair specific HO offsets for the active mode.

This cell-pair specific HO offset for the active mode may be used for HO purposes. It is noted that a cell may be free to initiate a HO of a UE to a neighbor cell at any time due to any reason. However, for successful and stable LB purposes, the target cell shall not initiate a HO back to the overloaded source cell immediately after the UE has been handed over, because of the better radio conditions the UE experiences in the source cell.

Hence, cell-pair specific HO offsets may be agreed on between two adjacent cells. By default this HO offset may be set to 0 dB, i.e. a UE may be served by the strongest cell in its vicinity (except for the fact that another HO parameter that defines a HO hysteresis may have an impact on which cell serves the UE).

For performing an LB-HO, the cell-pair specific HO offset of the two cells involved may be modified to avoid any prompt and undesired “Handover Desirable for Radio Reasons” back to the overloaded cell. In principle, this HO offset for active UEs can be combined to either offsets for event triggering of measurement reports for active mode UEs or with offsets which have impact on the camping decision of idle mode UEs.

The HO offset may be dynamically modified by the load balancing function. The term HO offset may also comprise a set of HO offsets that is, e.g., negotiated.

### Process of Negotiation:

In case an overloaded cell A proposes a new offset value Δ_{A,B}^{new} to a target cell B with a current offset value of Δ_{A,B}^{current}, the target cell B processes this request and provides a response value

Δ_{A,B}^{current}≦Δ_{A,B}^{respond}≦_{A,B}^{new}.

The values Δ may be similar to the values Qoffset for idle mode and event triggering.

FIG. 1 shows a handover parameter coordination procedure in a distributed approach comprising the case of an accepted request and the case of an rejected request between two eNBs.

FIG. 1 shows a coordination procedure for cell-pair specific offset modifications for a system that is not controlled by a centralized load balancing function. Hence, a negotiation process is required to agree on new offset values for the involved adjacent eNBs. Because of no central control entity being involved, this scenario can be referred to as a decentralized approach.

By sending a CELL PAIR COORDINATION REQUEST message, the eNB1 informs the eNB2 about an offset value that is planned by the eNB1, e.g., the eNB1 may want to reduce the offset value by −12 dB. The eNB2 checks whether such request can be fulfilled and in the affirmative, the eNB2 informs the eNB1 about its amended parameter setting by sending a CELL PAIR COORDINATION RESPONSE message, which may comprise the same value with a reverse sign, i.e., +12 dB according to this example. Otherwise, the eNB2 responds with a CELL PAIR COORDINATION REJECT message.

It is noted that in case of trailing negotiation applied by eNB1, the eNB2 may have no reason to reject eNB1's request, because the request means just adapting the cell border to the actual situation that has been changed due to the LB-HO already conducted. Thus, when the eNB1 sends the request, the eNB1 already knows where the new cell border should be set to, because this would correlate to the already successfully performed LB handovers.

The process of negotiation may be initiated per cell-pair specific parameter negotiation. Only one negotiation per cell may be allowed at any point in time. As the procedure can be utilized by other SON functions, it could be advantageous to indicate the purpose of the negotiation in the request, e.g., comprising a “Load Balancing” flag or an indication in the message conveyed.

If the delta value that is requested by eNB1 is too high, the eNB2 may return a smaller value in a CELL PAIR COORDINATION RESPONSE message. This smaller value can be used by the eNB1 as a value mutually agreed upon.

Furthermore, the negotiation may be improved such that a request from one cell may be answered by one of the following:
(a) A message proposing another, smaller value than that of the received request;
(b) An accept message, which successfully terminates the procedure and enforces the value of the most recent request;
(c) A reject message, which unsuccessfully terminates the procedure without enforcing any modification.

FIG. 2 shows a message diagram depicting an alternative handover parameter coordination procedure in a distributed approach comprising the case of an accepted request and the case of a rejected request between two eNBs.

The coordination comprising the negotiation is terminated by either an accept message or a reject message by the eNB that has received the most recent request, which is indicated by using double arrows in FIG. 2.

FIG. 3 shows a message diagram visualizing a centralized approach for a handover coordination procedure between a centralized function and a eNB allowing for cell-pair specific offset modifications for a system that is controlled by a centralized load balancing function.

Hence, the negotiation process between the adjacent eNBs is not required, because the centralized load balancing function has control over both eNB1 and eNB2. Both eNBs may receive new settings for their cell-pair specific offset values. The centralized function could be located in or be associated with any Element Manager, OAM node or an independent network element dedicated to provide SON functionality.

### OAM Aspects

In order to apply operator policies and enable configuration, performance, and fault management, also part of the overall management may advantageously be associated with OAM functionality and/or deployed with an OAM entity.

A central control entity or a function thereof is also referred to as “Operation and Maintenance” (OAM).

It is suggested enabling central control and configuration of a distributed load balancing functionality in particular according to at least one of the following concepts:
(a) OAM may be able to switch off LB for individual cells. Such a cell is not allowed to request load balancing, i.e. it is not allowed to initiate LB-HOs, nor is it allowed to send new proposals for HO offset values. As a consequence, such a cell may not accept proposals for new HO offset values either, because it would not be able to shift the cell boundary.
(b) OAM could configure an upper load threshold for cells for which load balancing is enabled, wherein such upper load threshold may trigger any load balancing action.
   In general, the upper load threshold may be defined based on a measure of the load of the cell, e.g., an (average) number of used PRBs in case of radio load. Separate thresholds may be provided for different resource types (transport network load, hardware load, radio load), and/or for different bearer types (signaling radio bearers, guaranteed bit rate (GBR) bearers, non-GBR bearers).
   In order to simplify configuration, to facilitate multi-vendor deployment and to ensure future evolution, it could be a preferred option to only signal one compound load threshold. In this case, the single threshold could be used for the scarcest resource, e.g., in case a transport network load amounts to 90% and the radio load is 70%, the transport network load will be compared with the threshold, whereas in case the transport network load is 90% and radio load is 95%, the radio load would be compared with the threshold.
(c) The load threshold could be based on a standardized measurement definition for load, which might include adjustable parameters that would need to be configured by OAM such as, e.g., an averaging window for load measurements.
(d) OAM could configure a low load threshold, which may trigger an attempt to switch off a cell, e.g., for energy saving purposes.
(e) OAM may configure maximum limits for HO offsets to be used by an eNB for LB purposes.
   A maximum possible value to be used for HO offsets could be set to ±24 dB. However, using high values could be deemed detrimental, because of, e.g., an uplink link budget and/or interference reasons.
   Furthermore by setting the maximum limit to the highest possible value for LB reasons, the degree of autonomy (and therefore an impact on the pre-planned network configuration) of the decentralized part may be constrained.
(f) A configuration of load signaling over an X2 interface between adjacent eNBs may enable to trade-off an actuality of information vs. a load and overhead at the X2 interface.
   Load reporting may be based on differential changes with regard to the current status, parameters to be configured are the minimum load change before a report should be triggered (<MinLoadChange>), <MinLoadIncrease> and/or <MinLoadDecrease> in case different intervals should be used for load increase and/or decrease, respectively.
   The eNBs may work based on a basic pre-configuration and may be fully aware of how to adapt these triggers according to current needs. Nevertheless, OAM could provide configuration and overrule such a decentralized adaptation of the triggers if this would be required.
(g) A configuration of HO offset negotiation over the X2 interface, i.e. the process, how two eNBs agree on a change of HO offsets, can be controlled by the OAM in particular by setting the following parameters:
   A timer for negotiating a new HO offset;
   Provide HO offsets to be used, e.g., in order to reset the decentralized algorithm and/or to adapt to larger offline re-planning results not visible or known to the eNB.

FIG. 4 shows the overall LB architecture and the function split between centralized and decentralized LB. A NE 509 is connected with a NE 510 via an X2 interface. The NE 509 supplies cells 501 to 503 and the NE 510 supplies cells 504 to 506. The NE 509 is connected to an access gateway (aGW) 507 via an S1 interface. The aGW 507, the NE 509 and the NE 510 are connected to a OAM system 508 as indicated by lines 511 to 513. The NE 509 and the NE 510 each comprises decentralized LB functions. Via said lines 511 to 513 the decentralized LB functions are controlled and configured by the OAM system 508, which also provides centralized LB functionality using a management interface, e.g., Itf-N. The split into centralized and decentralized LB functionality is also referred to as hybrid architecture.

The handovers that cause load balancing, an associated X2 load signaling and the HO offset negotiation between a pair of cells can be performed by the decentralized portion of the LB functionality deployed with the NEs 509, 510 (which may in particular be realized as eNBs). An associated signaling between the NEs 509, 510 is provided by the X2 interface.

A particular advantage of this approach is that an overhead, delay and required processing power can be significantly reduced as functionalities being distributed among the network nodes according to the information available. As a further advantage, legacy equipment can be used and/or upgraded in a cost efficient manner.

The approach furthermore provides a flexible framework which can be configured from a centralized setting, e.g., by
setting the maximum limits for HO offsets to be used by a eNB for LB reasons to ±0 dB, and/or
setting a HO offsets via OAM
   to a mainly decentralized approach, where few constraints on the HO offsets to be used by the eNB are imposed and where eNB negotiations are not overruled by OAM-configured HO offsets.

FIG. 5 shows an example of LB thresholds with an upper threshold for the load set by the OAM to 90% PRB usage. According to the example shown in FIG. 5, a total radio load (given by signaling radio bearers (SRB), GBR bearers and non-GBR bearers) amounts to 98% and exceeds the threshold set by OAM. LB is initiated. A lower threshold of 10% has been configured in order to initiate switching off the eNB (e.g. for energy-saving reasons).

FIG. 6 shows the use of a compound LB threshold. The maximum load is determined via the resources radio network, transport network and hardware (optionally, also via other types of resources). In the example of FIG. 3 the load of the radio network amounts to 70%, the load of the transport network amounts to 93% and the hardware load is 20%. The highest load, here the load of the transport network amounting to 93%, is compared to the upper threshold of 90% indicating that the threshold is exceeded. Thus, load balancing may be initiated.

It is noted that when conducting a comparison with the lower threshold typically only the user traffic is of interest and therefore the radio load of the network could be used. In case the eNB provides additional services other than supporting and carries its own radio load via its transport link, the transport load could be considered in an assessment whether or not the lower threshold is reached.

### Determination of Load Information

Load balancing mechanisms can be in particular effective when load information is being exchanged.

A cell (of a eNB) may at least inform its neighboring cells (of another eNB) to what extent it could accommodate UEs which currently are connected to a congested cell. Advantageously, such information may be as precise as possible. In turn, the congested cell can derive from this information an appropriate action, such as handovers towards the uncongested cell, negotiations of new cell boundaries, etc. Based on an accurate assessment of the congestion level of a potential target cell, the congested cell may choose an appropriate setting, e.g., for HO offset values.

The ability of accommodating load from congested neighbors can be limited according to the following aspects:
(a) Radio resources: A primary limitation refers to the physical radio resources. For instance, in LTE with 10 MHz, the spectrum is divided into 50 physical resource blocks (PRBs), which can be re-assigned to UEs every 1 ms. If all PRBs are occupied, a cell is typically referred to as being “100% loaded” (or overloaded). If not all PRBs are occupied, the cell can accommodate further UEs (from the radio perspective).
(b) Transport capacity: Even in case of sufficient radio resources, another limitation may apply regarding a congestion level on the backhaul network. In such case, no UE from other cells may be accommodated even in case of many unused PRBs.
(c) Baseband capacity: Accordingly, a baseband capacity may have restrictions in terms of supported users.
(d) Control Channels: Even if enough radio resources on the (shared) data channels are available, a structure of control channels may prevent further UEs from being handed over to this cell.
(e) Traffic variation: Even if none of the aforementioned limitations apply for a given amount of time, the cell may not accommodate additional traffic, if it expects a significant increase of load in the near future. That might be the case if a cell is aware of heavy load variations or if it wants to protect high-priority resources for important traffic, e.g., for preferred users.
(f) Also, vendor specific limitations may apply.

Load information is required for a congested cell to direct HO requests to cells which can cope with the additional load. Without such information, a congested cell may blindly launch HO requests towards its neighborhood, which may or may not be successful thereby leading to additional traffic with a high risk of failure and/or a high risk of bouncing back leading to useless repetitions of HO requests.

On the other hand, if the congested cell is well aware of the load situation of the target cell, the following advantages apply:
(a) Unnecessary signaling overhead is avoided as there is a reduced likelihood of the HO request being rejected.
(b) The HO requests launched are efficient: The HO requests may be triggered in a well-defined order considering the fact that the best candidates for target cells are addressed first.
(c) The approach reaches a high degree of stability as there is no “blind” request that may bounce back. The HO requests are not triggered arbitrarily, but with the knowledge of the load situation of the target cell.

Hence, a load information of the target cell can be utilized for efficient load balancing.

Conveying the load information leads to additional signaling traffic. However, this overhead traffic can be minimized by informing the neighboring cells about the load situation in an efficient way.

It is noted that the reporting cell may have a preferred knowledge of its own QoS requirements. Advantageously, QoS may be considered in the cell's load report. Hence, the receiving entity of the load report may take into account this information as well rather than assessing or interpreting other data received to obtain a QoS requirement of the target cell, if possible at all. Accordingly, other kind of limitations may also be provided with the load report.

Preferably, the cell receiving the load report may be informed about limitations in total rather than in the individual components. In other words, the cell receiving the load report may advantageously be informed about the amount of traffic that can be handed over to the reporting cell.

It is hence suggested that the reporting cell—rather than signaling each and every component—generates an “effective load” report which contains exactly the information that the receiving cell needs to know, considering any kind of limitation which may apply.

The limitations (e.g., PRB usage) may be separated from their respective causes (hardware load, transport network layer (TNL) load, radio network load) and only the limitations may be conveyed in the load report. This allows the reporting cell to signal any kind of cause, in particular vendor-specific causes in addition to standardized causes. The receiving entity may only care about the limitations, not the respective causes.

The load report may comprise a single field or number compressing the information available at the reporting cell into an efficient format. However, also a lot of different types of information can be compressed this way in an efficient manner to reduce the overall signaling overhead regarding the load report. In particular, several pieces of information can be mapped to a single number indicating the actual traffic condition of the potential target cell. Such mapped information can be directly used by the source cell for load balancing purposes.

In addition or as an alternative, the following information may be conveyed with the load report:
A number N of “effective” PRBs used; hence, the receiving eNB knows that N_total−N_PRBs are available for load balancing purposes;
An available number of N PRBs for load balancing.

Either one of the information conveyed in the load report may be expressed in relative terms (e.g., in %).

Existing signaling formats, e.g., plain PRB usage, could be used, and the interpretation could be changed at the receiving cell.

Advantageously, the cell receiving the load report is aware of the format and knows how to interpret, e.g., a field or number provided with the load report. In case a format known to other cells is used, each cell receiving a load report is aware of the fact the other neighbors may be aware of and may utilize the resources of the reporting cell as well. Alternatively, the reporting cell may split its available load among its neighbors, and provide load reports accordingly, i.e. the reporting cell may signal an individual report to each neighbor. In this case the receiving cell may assume that the signaled resource can be exclusively utilized.

It may be further specified, when load reports are (to be) sent. At least one of the following options may apply:
Periodic reporting;
Event-based “on/off”: Reports are only sent if at least one neighbor has requested this report. Hence, in a scenario of low load (without the necessity of LB), the load reports could be at least temporarily (or completely) switched off. This could be accomplished, e.g., by sending a 1 bit information to neighboring cells indicating that load reports are required or not.
Event-based “delta-based”: If a report is requested, it can be sent immediately, and afterwards only if the effective load has changed by more than x % (e.g., more than 5%).
Any combination from the aforementioned options may apply, e.g., a decreasing load is signaled periodically (with large periodicity) whereas an increasing load is signaled with “delta-based triggering”.

It could be advantageous to express the load limitations in several units, e.g.
a maximum number of available PRBs for load balancing;
a maximum data rate to accommodate (which may be useful for providing limitations regarding the backhaul);
a maximum number of users to be accommodated (which may be useful for providing baseband and/or control channel limitations).

It is noted that herein “cells” are referred to as exchanging load information. The cell may be associated with a network element, e.g., a base station or a NodeB (eNB) that may actually convey the information to another network element.

In LTE, an eNB may serve several cells and it may collect load information from all of its served cells (also referred to as sectors). The eNB may send this load information to eNBs, which serve a neighbor cell to at least one of its served cells. In other words, load information may not be exchanged between the cells, but between their serving eNBs so that cells receive load information not only from their direct neighbors.

In particular, the following advantages apply:
More relevant information are conveyed to the congested cells via load reports, i.e. overloaded cells can initiate well-directed load-balancing/HO requests to its neighboring cells.
Signaling overhead can be reduced as the reporting cell may include the load information into a single report, rather than reporting many different measures.

### LIST OF ABBREVIATIONS

3GPP 3^{rd} Generation Partnership Project
BS Base Station
CDF Cumulative Distribution Function
EM Element Manager
eNB evolved NodeB (Base Station of the E-UTRAN)
FDD Frequency Division Duplexing
GBR Guaranteed Bit Rate
GSM Global System for Mobile communications
HO Handover
ISD Inter Site Distance
Itf-? Interface between EM and NE, wherein ? is a placeholder, e.g., Itf-R, if NE is a RNC; or Itf-B, if NE is a NodeB
Itf-N Standardized interface between NM and EM or sometime NM and NE
LB Load Balancing
LTE Long Term Evolution
NE Network Element (e.g., RNC, NodeB or eNodeB)
NM Network Manager
NodeB NodeB (Base Station of the UTRAN)
OAM Operation and Maintenance
PRB Physical Resource Block
QoS Quality of Service
RNC Radio Network Controller
RSRP Received Signal Reference Power
SON Self Organizing Network
SRB Signaling Radio Bearer
TDD Time Division Duplexing
UE User Equipment
UMTS Universal Mobile Telecommunications System
UTRAN UMTS Terrestrial Radio Access Network

1.-15. (canceled)

16. A method performed in a mobile communication network, comprising:
performing by a base station in a first cell a negotiation of a handover parameter at least by performing:
signaling by a base station the handover parameter from a first cell to a second cell, wherein the handover parameter indicates a modification to a handover offset relative to a handover offset currently being used for handover of mobile terminals, wherein use of the modification in the handover offset is for load balancing in the first cell; and
using by the base station the negotiated handover parameter to handover at least one mobile terminal from the first cell to the second cell.

17. The method of claim 16, wherein handover offsets are used to prevent handovers back to the first cell.

18. The method of claim 16, wherein performing by a base station in the first cell the negotiation of the handover parameter is performed at least by performing: signaling by the base station in the first cell a cause value from the first cell to the second cell, the cause value indicating a mobile terminal was handed over from the first cell to the second cell because of load balancing in the first cell, wherein the signaling of the cause value is performed prior to the signaling of the handover parameter.

19. The method of claim 16, wherein the handover offset is a cell-pair specific handover offset of the first and second cells, and the negotiation is performed to modify the cell-pair specific handover offset to avoid any prompt and undesired handover desirable for radio reasons back to the first cell.

20. The method of claim 19, wherein the cell-pair specific handover offset for active mobile stations can be combined either with offsets for event triggering of measurement reports for active mode mobile stations or with offsets which have impact on camping decisions of idle mode mobile stations.

21. An apparatus, comprising:
a processor configured to cause the apparatus to perform operations comprising:
performing by a base station in a first cell a negotiation of a handover parameter at least by performing:
signaling by a base station the handover parameter from a first cell to a second cell, wherein the handover parameter indicates a modification to a handover offset relative to a handover offset currently being used for handover of mobile terminals, wherein use of the modification in the handover offset is for load balancing in the first cell; and
using by the base station the negotiated handover parameter to handover at least one mobile terminal from the first cell to the second cell.

22. The apparatus of claim 21, wherein handover offsets are used to prevent handovers back to the first cell.

23. The apparatus of claim 21, wherein performing by a base station in the first cell the negotiation of the handover parameter is performed at least by performing: signaling by the base station in the first cell a cause value from the first cell to the second cell, the cause value indicating a mobile terminal was handed over from the first cell to the second cell because of load balancing in the first cell, wherein the signaling of the cause value is performed prior to the signaling of the handover parameter.

24. The apparatus of claim 21, wherein the handover offset is a cell-pair specific handover offset of the first and second cells, and the negotiation is performed to modify the cell-pair specific handover offset to avoid any prompt and undesired handover desirable for radio reasons back to the first cell.

25. The apparatus of claim 24, wherein the cell-pair specific handover offset for active mobile stations can be combined either with offsets for event triggering of measurement reports for active mode mobile stations or with offsets which have impact on camping decisions of idle mode mobile stations.

26. A base station, comprising:
a processor configured to cause the base station to perform operations comprising:
performing by the base station in a first cell a negotiation of a handover parameter at least by performing:
signaling by a base station the handover parameter from a first cell to a second cell, wherein the handover parameter indicates a modification to a handover offset relative to a handover offset currently being used for handover of mobile terminals, wherein use of the modification in the handover offset is for load balancing in the first cell; and
using by the base station the negotiated handover parameter to handover at least one mobile terminal from the first cell to the second cell.

27. The base station of claim 26, wherein handover offsets are used to prevent handovers back to the first cell.

28. The base station of claim 26, wherein performing by a base station in the first cell the negotiation of the handover parameter is performed at least by performing: signaling by the base station in the first cell a cause value from the first cell to the second cell, the cause value indicating a mobile terminal was handed over from the first cell to the second cell because of load balancing in the first cell, wherein the signaling of the cause value is performed prior to the signaling of the handover parameter.

29. The base station of claim 26, wherein the handover offset is a cell-pair specific handover offset of the first and second cells, and the negotiation is performed to modify the cell-pair specific handover offset to avoid any prompt and undesired handover desirable for radio reasons back to the first cell.

30. The base station of claim 29, wherein the cell-pair specific handover offset for active mobile stations can be combined either with offsets for event triggering of measurement reports for active mode mobile stations or with offsets which have impact on camping decisions of idle mode mobile stations.
